(19) United States
(12) Patent Application Publication
(10) Pub. No.: US 2025/0383925 A1
(43) Pub. Date: Dec. 18, 2025

(54) DIGITAL TWIN MODEL LIBRARY MANAGEMENT WITH OPTIMIZATION FOR COMPRESSION

(71) Applicant: Dell Products L.P., Round Rock, TX (US)

(72) Inventors: Herberth Birck Fröhlich, Florianópolis (BR); Vinicius Michel Gottin, Rio de Janeiro (BR); Marcus Vinicius Libardi Pazini, Caxias do Sul (BR)

(21) Appl. No.: 18/747,201

(22) Filed: Jun. 18, 2024

(51) Int. Cl. G06F 9/50

(52) U.S. Cl. CPC G06F 9/5027

(57) ABSTRACT

One example method includes receiving a DTC (digital twin configuration) that is configured to perform a predefined task, and the DTC comprising component sets, when it is determined that models of one of the component sets can be executed simultaneously, staging the models, beginning execution of the one component set, and calculating available resources, and, when the available resources are below a threshold, waiting until the one component set is executed, and then unstaging one or more of the models of the one component set, and when the available resources are at or above the threshold, staging a model of a next one of the component sets.

### TECHNOLOGICAL FIELD OF THE DISCLOSURE

Embodiments disclosed herein generally relate to the configuration and use of digital twins. More particularly, at least some embodiments relate to systems, hardware, software, computer-readable media, and methods, for configuring digital twins and digital twin model library management.

### BACKGROUND

A Digital Twin (DT) configuration is defined with respect to the required components for an application, which may be related to a domain issue or question. A same DT may answer many different operational questions and the necessary components may vary over time. That is, the configuration of a DT changes based on the purpose of its application.

The components that make up a DT configuration may be numerous, and some may be large and computationally expensive. It is sub-optimal, or even not feasible, to have all of the components pre-loaded and always executing in the computational infrastructure. Hence, the DT may have to stage/unstage the currently necessary/unnecessary components to function properly or optimally.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of an example of a line of work with a story line comprising two DTCs that share one component set C₁, where each DTC is responsible for solving a predefined task, according to one embodiment.

FIG. 2 discloses aspects of a method according to one embodiment.

FIG. 3 discloses an example iteration of a staging process, according to one embodiment.

FIG. 4 discloses a computing entity configured and operable to perform any of the disclosed methods, processes, and operations.

### DETAILED DESCRIPTION OF SOME EXAMPLE EMBODIMENTS

Embodiments disclosed herein generally relate to the configuration and use of digital twins. More particularly, at least some embodiments relate to systems, hardware, software, computer-readable media, and methods, for configuring digital twins and digital twin model library management.

A method according to one embodiment may comprise an orchestration process that tracks the infrastructure resources and the current, and future, required configurations of a DT for adaptively unstaging components, such as by compressing the components into available storage, and preemptively staging the components, such as by decompressing and deploying the components to the infrastructure. In an embodiment, an orchestration process may operate to minimize the ‘downtime’ of the DT between the implementation of different configurations of the DT.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiments is that an embodiment may minimize the DT downtime needed to reconfigure the DT. An embodiment may optimize the staging, and unstaging, of one or more components of a DT. An embodiment may adaptively stage, and unstage, one or more components of a DT. An embodiment may optimize the use of available resources when staging one or more components of a DT. An embodiment may stage one or more components of a DT in a way that meets specified DT parameters, such as simulation quality and prediction response time. Various other advantages of one or more example embodiments will be apparent from this disclosure.

### A. Overview of Aspects of an Example Embodiment

One example embodiment comprises an orchestration service that tracks the infrastructure resources and the current—and future—required configurations of a DT for adaptively unstaging components, such as by compressing the components of the DT into available storage, and preemptively staging components of a DT, such as by decompressing and deploying the components to an infrastructure. The orchestration aims at minimizing the ‘downtime’ of the Digital Twin between configurations.

In one embodiment, this orchestration procedure is related to one of the six major groups of Digital Twin requirements from the Digital Twin Capabilities Periodic Table (see Digital Twin Capabilities Periodic Table—A Digital Twin Consortium User Guide, Digital Twin Consortium, 28 Mar. 2022) (which is incorporated herein in its entirety by this reference), the Data Services. Specifically, the Digital Twin & Simulation Model Repositories, where the purpose is to register and manage a portfolio of model elements in a central repository, that is, the model library, to improve configuration management and model governance. One embodiment may be is related to the Immersive Enterprise Research Theme, where Digital Twin is an enabling technology.

A method according to one example embodiment may orchestrate the staging/unstaging of Digital Twin Configuration (DTC) models. This may be achieved by a constant, greedy comparison between the system resources, such as data storage and processing power, and the DTC requirements to avoid idleness and bottlenecks. In situations where a set of models cannot be loaded at once, an embodiment may apply an optimization method to build an organized queue of compression. This optimization method may consider storage and processing power as constraints and time to decompress as values to be optimized.

Thus, an embodiment may comprise an approach in which an orchestration procedure receives components and system properties to compress and decompress the component files. In contrast, there do not presently appear to be any approaches based on such a modular framework to intelligently stage and unstage DT models.

### B. Detailed Discussion of Aspects of One Example Embodiment

### B.1 Overview of Some Aspects of Digital Twin Configurations (DTC)

As used herein, a DT may comprise a virtual representation of one or more physical entities that are modeled and assembled in a way that allows a simulation to be executed by the DT. The difference from traditional simulation is that the result of this DT simulation traverses back and influences the operation, closing the information loop. A DT of a wind turbine, for example, may be used to generate many what-if scenarios based on ongoing metrics, and these scenarios may be used to determine operations characteristics such as blade angle of attack. In another scenario, all logistics may be virtualized to optimize the routes.

The purpose(s) or application(s) of a DT may determine a particular DTC, or DTCs, for that DT. The DTC may identify several business or domain questions that the DT is configured, or configurable, to answer, or in support of a system or processing for obtaining such answers. The same DT may be expected to perform alternative lines of work using different DTCs over time by reconfiguring itself to meet a demand. For example, consider an assembly line where a DT is responsible to predict the number of products produced per hour. This DT should be able to adapt itself not only for different products but also for different purposes.

It is noted that in an embodiment, a DTC is related, but not identical, to its implementation as a group of one or more components. The components of a DT are its software and hardware modules, which are composed and configured to perform the line of work of that DT. Different configurations may be applied to the components to allow the whole system to perform an alternative line of work. Considering the same example assembly line referred to above, if this assembly line is changed to produce servers instead of notebooks, it may be reasonable to change the components of the DT that are related to the parts and the prediction model, among others.

An embodiment may assume that a current line of work and corresponding component configuration of the DT is known and, further, that a storyline of the next line(s) of work for that DT is available. The storyline determines both the sequence of lines of work, as well as the respective durations and starting times of those lines of work. In some domains, this may be known with exact precision, particularly when the lines of work are determined by a domain specialist or deterministic planning process. In other domains, a method for estimating the most probable sequence of lines of work may be necessary.

For the purposes of this disclosure, storyline SL, Digital Twin Configuration DTC, and component set C, are defined as follows:
SL={DTCₐ, DTC_{b}, DTC_{c}, . . . DTCₙ}; digital twin configurations DTC and a sequence of execution.
DTC={C₁, C₂, C₃, . . . , Cₙ} # component sets C, their identifiers, and the sequence of execution in terms of their identifiers.
C=[m₁, m₂, . . . , mₙ] # cluster containing a certain number of model elements m. These should operate in parallel if that is the case, but they are not required to be fetched this way, as discussed below. In one embodiment, a model is the smallest virtual entity that defines a physical entity.

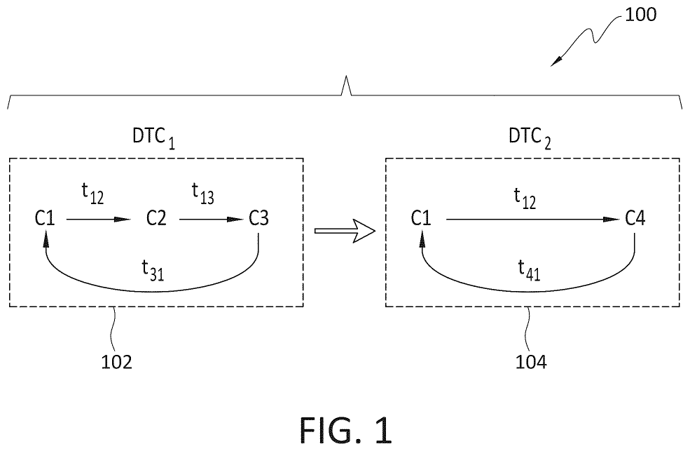

With attention now to FIG. 1, an example SL 100 is disclosed. As shown, the SL 100 comprises two DTCs 102 and 104, namely, SL 100={DTC₁, DTC₂}. In the illustrative, but non-limiting, example of FIG. 1, DTC₁ 102 encapsulates three component sets, namely, C₁, C₂, and C₃ which, in an embodiment, are executed in a loop.

As further indicated in FIG. 1, DTC₂ 104 shares, with DTC₁ 102, the component set C₁ but also requires one new component set, C₄. Suppose that, for the purposes of this example, the component sets are built as following C₁=[m₁, m₃]; C₂=[m₅]; C₃=[m₃, m₄, m₅], and C₄=[m₃]. Here, a component m may take various forms including, but not limited to, a hardware virtual entity, a software, or a machine learning model, for example. It is noted that the time that it takes for a component set to be executed is known, and represented as t. This time may be useful at least insofar as it sets the resource time consumed by a staging process and this information may be used to avoid bottlenecks or delays in the execution of DTC component set(s).

### B.2 Components (Models) and Resource Requirements/Constraints

As note earlier herein, each DTC has its own components sets, each of which comprise different small elements, that is, the models of physical entities of the DTC, present in a major library that is always available. In an embodiment, it may be important to load only the relevant resources of the DTC, so as to avoid unnecessary computation, and storage consumption, or to meet DTC simulation quality and prediction response time constraints. In this case, the resources are the models, and the models may be staged/unstaged to build the component sets so the components sets can operate in the right order and in the right time.

With regard to the resource(s) and constraint(s) applicable in a given case or DTC, a user may, in one embodiment, set the availability and thresholds for the operation. Regardless of the choice, an embodiment may assume that every resource must be known in advance for each model and must be constant during the execution. An embodiment may further assume that the time to fetch the models is always the same, as those models may come from the same database. Attributes not directly related to the models, for example, the total execution time for a component, may also be inserted. In an embodiment then, the resources are the constraints used for direct staging and for the queuing process, which may comprise a greedy process or may be implemented by an optimization algorithm.

### B.3 Dynamic Staging and Unstaging of DTCs

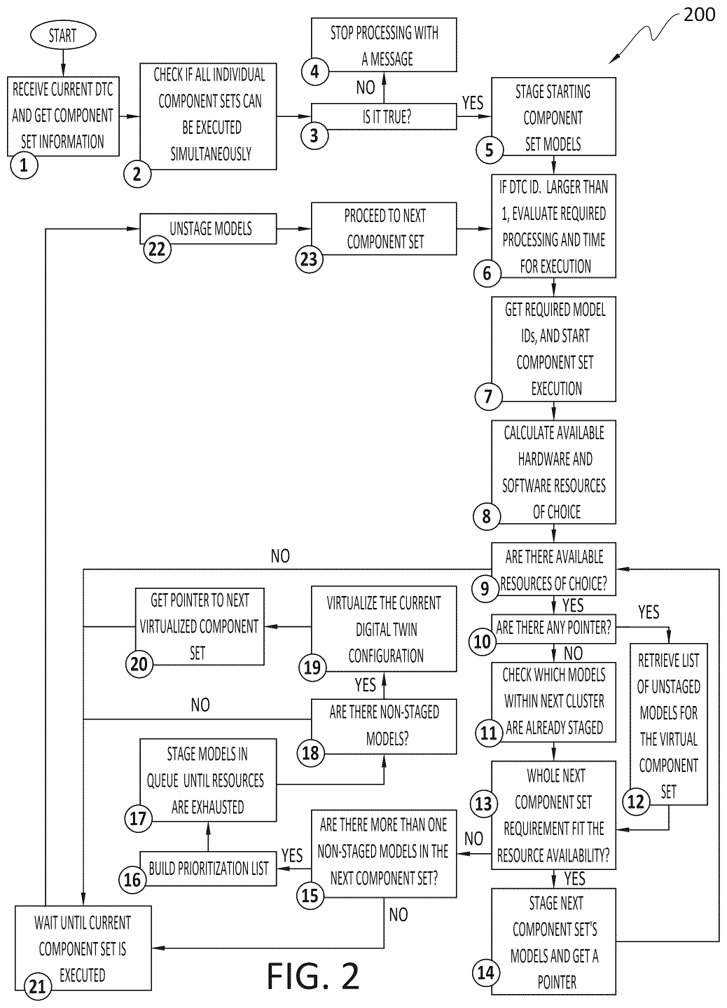

One example embodiment comprises a multi-step method for dynamically staging and unstaging components, or models, generating a setup and teardown plan for component sets to account for a storyline comprising lines of work, also known as DTCs. The method runs in parallel and in the background, using remaining resources and not interfering with the ongoing execution. One example embodiment of such a method is disclosed in FIG. 2, discussed below.

In one embodiment, this method is constantly executing a greedy search to prefetch all models of the component sets so as to avoid bottlenecks that might otherwise occur if one or more of the models were not prefetched. When this is not possible, the method may stage certain models of the next component set in an optimized way, aiming for damage control by reducing the waiting time as much as possible. Note that as used herein, damage control embraces, but is not necessarily limited to, controlling the amount of time that a DTC spends waiting to perform its predefined task(s), where the less such time spent, the better.

Related to this damage control is the prioritization list building and its motivation. This may be required because a situation may arise where prefetching models from component set Cₜ₊₁ takes more time than the time in between component sets Cₜ and Cₜ₊₁ execution. Even in this situation, it may be useful to run the prioritization since the alternative solution is to queue all staging after t, causing an even larger waiting time and/or a bottleneck. In an embodiment, however, this is only necessary if execution time is within the resources of choice.

An embodiment thus may comprise a strategy for queueing of component sets while avoiding prioritization running on already staged and/or unnecessary models, namely virtualization, which generated Virtual Digital Twin Configurations (vDTCs). Component set virtualization is the process of decomposing a component set considering the available resources and already staged models. Following is an explanation of component set virtualization with an example according to one illustrative embodiment:

Consider a DTC composed of three component sets, as follows,

$${DTC}_{original} = \{ [ {M}_{1} , {M}_{2} ] , [ {M}_{3} ] , [ {M}_{1} , {M}_{3} , {M}_{4} , {M}_{5} ] \} .$$

This DTC may be tagged as ‘original’ because the execution is only related to these three original component sets. Suppose that the staging process proceeds until C₃ ([M₁,M₃,M₄,M₅]) is required. Model M₁ is already staged, as shown in the component set C₁=[M₁,M₂], thus model M₁ is not required to be staged again, and suppose further that there are no resources available to stage the remaining models that are included in C₃, namely, the models [M₃,M₄,M₅]. Thus, the remaining models [M₃,M₄,M₅] of C₃ are queued using the appropriate constraints and prioritization technique, resulting in:

$${DTC}_{virtual} = \{ [ {M}_{1} , {M}_{2} ] , [ {M}_{3} ] , [ {M}_{1} ] , [ {M}_{3} , {M}_{4} , {M}_{5} ] \} .$$

It is noted that there are, now, four component sets, and the term “Next component set” in a scheme according to one embodiment refers now to [M₃,M₄,M₅]. In an embodiment, a pointer is another tool that may be used in this context, and the pointer signalizes the next component set. In this example, the pointer=4, meaning that the fourth component set, C₄ ([M₃,M₄,M₅]), in the virtualized component set will be further analyzed.

### C. Aspects of an Example Method

It is noted that any operation(s), or stages, of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, an example method 200 according to one embodiment is disclosed. Following is a description of each stage of the example method 200.
1. Start by receiving the current DTC from the Story Line (SL) and extracting the model point in the component set.
2. All models from the first component set at moment t are staged—an embodiment may assume that this starting cluster can always be loaded. If that is not the case, a message of error is prompted to the user.
3. Check if all starting component set models can be staged and executed by the system. If that was not the case, stage 4 takes place. If the procedure was successful, the method 200 continues to stage 5.
4. Outputs that entire process is interrupted due to lack of system resources to start the Story Line.
5. Stage all models from the starting component set.
6. If the component set is not the first one, calculate the remaining resources.
7. Get required models Ids and start the execution of the component set—models may operate in parallel and in the background. The virtualized digital twin configuration is a way to facilitates the staging process, and should not interfere with the execution, that is, there is not a need to roll back it to the original Digital Twin Configuration since all that matters is if the required components are staged in this stage.
8. Calculate the available hardware and software resources of choice.
9. Check if the resources are above a certain threshold. There can be the case that the user does not want to use all resources but keep some for any purpose. If so, an embodiment may restrain the execution to the current cluster and wait until the stage is executed. If there are available resources, go to stage 10, or continue to stage 21 otherwise.
10. Check if there are any pointers. Pointers tell the method 200 where the staging procedure stopped and provide a mechanism to avoid going over and over those component sets where a decision has already been made. If there is a pointer, continue to stage 12. Proceed to stage 11 otherwise.
11 Check which models within the next component set are already staged. This stage may serve to avoid duplications.
12. Use the pointer and get the list of that component set, virtual or not, unstaged models.
13. Check if all next component set models—excluding those that were already unstaged—fit the system availability. If this is the case, proceed to stage 14. Proceed to stage 15, if not.
14. Load the next cluster entirely, whether the cluster is virtual or not. Go back to stage 9.
15. Check if there is more than one model to be loaded in the next component set. If this is not the case, that may mean that even this single model will not fit the system availability, hence proceed to stage 19. If there is more than one model, a queueing process must be executed—proceed to stage 16.
16. Execute an algorithm to build a prioritization list for the models. The algorithm must consider all the resources of choice. An optimization algorithm, such as greedy sorting, can be used.
17. Start staging models based on the priority queue until the remaining sources are depleted.
18. Is there any remaining model to be staged for the current component set? If YES, proceed to stage 19. Proceed to stage 21 otherwise.
19. These remaining models become a virtual cluster, which is added to the Story Line (SL) as a virtual DTC only for staging and unstaging purposes.
20. Update pointer value to the next non-staged component cluster in that virtualized digital twin configuration.
21 At this stage, no unstaging can be done. Wait until the current component set is executed to release resources.
22. Once the cluster is executed, check if any non-shared, loaded model can be unstaged, which is done if resources are available-and recall that shared models are identified during stage 11.
23. Finally, proceed to the next cluster execution and restart the whole procedure at stage 6.

### D. Illustrative Example

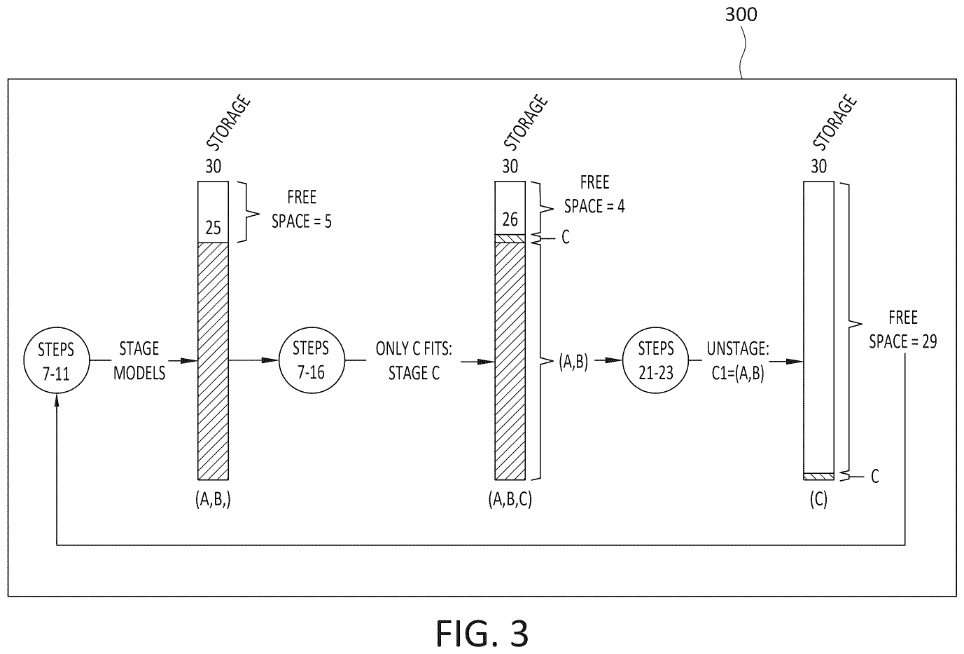

With attention now to FIG. 3, and continued reference to the various stages of the example of FIG. 2, an example method 300 according to one embodiment is disclosed. The example method 300, comprising a hypothetical, simplified example to demonstrate a method framework according to one embodiment, comprises various, but not necessarily all, components of this disclosure.

Consider the following list of models: models={‘A’: (10, 5), ‘B’: (15, 7), ‘C’: (1, 1), ‘D’: (8, 7), ‘E’: (20, 15), ‘F’: (1, 9), ‘G’: (2, 15)}; where the numbers represent the size in storage units needed to store the models, and the time to decompress (in time units) the models, respectively.

In the example of FIG. 3, there is an SL 300 with a single DTC, that is, SL 300={DTC₁}, where DTC₁ comprises three component sets, that include the following models [(A, B), (C, D, E), (E, G, H)], respectively. Suppose further that an associated storage infrastructure provides 30 storage units.

Since, in this example, the only constraint is available storage, it may be assumed for simplicity that there is adequate processing power available to execute all required tasks and that time is not a consideration, that is, a bottleneck may occur and that is permissible. Thus, the constraint, that is, the resource of choice, resides only in storage. Time, alone, will be used to build staging prioritization for the models.

Stages 1-6 (see FIG. 2) provide evidence and lead to Component Set 1 staging, since models A and B sum up to 25 storage units. Stage 7 starts this component set execution, and stage 8 yields 5 storage units to spare.

Stage 9 yields YES since there are enough storage units available. Stage 10 yields a NO because there are no pointers. Stage 11 indicates that there is no superposition, that is, the next component set shares no models with the ongoing component set. The models of the next component set sum up to 29, so stage 13 yields a NO, indicating it is impossible to stage all these next models. Stage 15 yields a NO because there is more than one model within the next component set, thus the embodiment needs to build a prioritization list, which happens in stage 16.

If there exists a situation where components from ComponentSet, or ComponentSetᵢ₊₁ loaded in the stage where ComponentSetᵢ₋₁ is being executed, the optimization algorithm of stage 16 can be used to lookahead and decide which are the most advantageous models M to keep in memory, thus, avoiding unnecessary staging or unstaging. The number of components k that the algorithm looks ahead (ComponentSetᵢ₊ₖ) can be defined by the user in combination with the type of optimization algorithm that was decided to be used to obtain the prioritization list in stage 16.

In this case, an embodiment may sort the models considering their respective storage requirements, and then, if there is a tie, this embodiment will use the time to decompress as a basis to support the models. If time in between component sets execution is a resource of choice, time could become the first attribute for sorting purposes. Among C, D, and E, only C fits within the 5 storage units available, thus this model is staged, stage 17 since there is no tie. Models D and E remain unstaged for the next component set, yielded by stage 18 analysis. Stage 19 builds a virtualized DTC=[(A, B), (C), (D, E), (E, G, H)], and stage 20 sets a pointer to 3, meaning that the analysis will continue with (D, E).

At this point, there is no way to stage more models, so the stage 21 commences. After that, stage 21 will unstage models (A, B) releasing some resources. The execution will go to component set (C, D, E). The, the process will restart, but it will consider that model C is already staged.

### E. Further Example Embodiments

Following are some further example embodiments. These are presented only by way of example and are not intended to limit the scope of this disclosure or the claims in any way.

Embodiment 1. A method, comprising: receiving a DTC (digital twin configuration) that is configured to perform a predefined task, and the DTC comprising component sets; when it is determined that models of one of the component sets can be executed simultaneously, staging the models; beginning execution of the one component set; and calculating available resources, and: when the available resources are below a threshold, waiting until the one component set is executed, and then unstaging one or more of the models of the one component set; and when the available resources are at or above the threshold, staging a model of a next one of the component sets.

Embodiment 2. The method as recited in any preceding embodiment, wherein the next component set comprises one of the models of the one component set that was previously staged for execution of the one component set.

Embodiment 3. The method as recited in any preceding embodiment, wherein the resources comprise processing and storage.

Embodiment 4. The method as recited in any preceding embodiment, wherein the unstaging comprises compressing and storing the one or more models.

Embodiment 5. The method as recited in any preceding embodiment, wherein the staging of the model of the next one of the component sets comprises decompressing the model.

Embodiment 6. The method as recited in any preceding embodiment, wherein when the available resources are at or above the threshold, remaining models of the next one of the component sets that cannot be executed with the available resources are prioritized for staging, relative to each other, based on respective resource requirements of the remaining models.

Embodiment 7. The method as recited in embodiment 6, wherein the remaining models are prioritized for staging based on respective storage requirements of the models and, when there is a tie between the respective storage requirements of two of the remaining models, those two models are sorted, relative to each other, using respective times needed to decompress those two models.

Embodiment 8. The method as recited in embodiment 6, wherein the remaining models are prioritized for staging based on an amount of time between execution of the component set and execution of the next component set.

Embodiment 9. The method as recited in any preceding embodiment, wherein the calculating of the available resources is performed on an ongoing basis using a greedy comparison between the resources and DTC requirements to avoid idleness and bottlenecks.

Embodiment 10. The method as recited in embodiment 9, wherein use of the greedy comparison minimizes an amount of time between a time when the one component set is executed, and a time when the next component set is executed.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

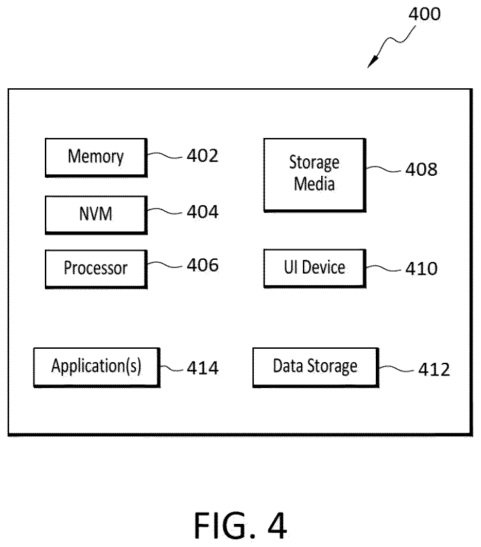

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving a DTC (digital twin configuration) that is configured to perform a predefined task, and the DTC comprising component sets;
when it is determined that models of one of the component sets can be executed simultaneously, staging the models;
beginning execution of the one component set; and
calculating available resources, and:
when the available resources are below a threshold, waiting until the one component set is executed, and then unstaging one or more of the models of the one component set; and
when the available resources are at or above the threshold, staging a model of a next one of the component sets.

2. The method as recited in claim 1, wherein the next component set comprises one of the models of the one component set that was previously staged for execution of the one component set.

3. The method as recited in claim 1, wherein the resources comprise processing and storage.

4. The method as recited in claim 1, wherein the unstaging comprises compressing and storing the one or more models.

5. The method as recited in claim 1, wherein the staging of the model of the next one of the component sets comprises decompressing the model.

6. The method as recited in claim 1, wherein when the available resources are at or above the threshold, remaining models of the next one of the component sets that cannot be executed with the available resources are prioritized for staging, relative to each other, based on respective resource requirements of the remaining models.

7. The method as recited in claim 6, wherein the remaining models are prioritized for staging based on respective storage requirements of the models and, when there is a tie between the respective storage requirements of two of the remaining models, those two models are sorted, relative to each other, using respective times needed to decompress those two models.

8. The method as recited in claim 6, wherein the remaining models are prioritized for staging based on an amount of time between execution of the component set and execution of the next component set.

9. The method as recited in claim 1, wherein the calculating of the available resources is performed on an ongoing basis using a greedy comparison between the resources and DTC requirements to avoid idleness and bottlenecks.

10. The method as recited in claim 9, wherein use of the greedy comparison minimizes an amount of time between a time when the one component set is executed, and a time when the next component set is executed.

11. A non-transitory storage medium having stored therein instructions that are executable by one or more hardware processors to perform operations comprising:
receiving a DTC (digital twin configuration) that is configured to perform a predefined task, and the DTC comprising component sets;
when it is determined that models of one of the component sets can be executed simultaneously, staging the models;
beginning execution of the one component set; and
calculating available resources, and:
when the available resources are below a threshold, waiting until the one component set is executed, and then unstaging one or more of the models of the one component set; and
when the available resources are at or above the threshold, staging a model of a next one of the component sets.

12. The non-transitory storage medium as recited in claim 11, wherein the next component set comprises one of the models of the one component set that was previously staged for execution of the one component set.

13. The non-transitory storage medium as recited in claim 11, wherein the resources comprise processing and storage.

14. The non-transitory storage medium as recited in claim 11, wherein the unstaging comprises compressing and storing the one or more models.

15. The non-transitory storage medium as recited in claim 11, wherein the staging of the model of the next one of the component sets comprises decompressing the model.

16. The non-transitory storage medium as recited in claim 11, wherein when the available resources are at or above the threshold, remaining models of the next one of the component sets that cannot be executed with the available resources are prioritized for staging, relative to each other, based on respective resource requirements of the remaining models.

17. The non-transitory storage medium as recited in claim 16, wherein the remaining models are prioritized for staging based on respective storage requirements of the models and, when there is a tie between the respective storage requirements of two of the remaining models, those two models are sorted, relative to each other, using respective times needed to decompress those two models.

18. The non-transitory storage medium as recited in claim 16, wherein the remaining models are prioritized for staging based on an amount of time between execution of the component set and execution of the next component set.

19. The non-transitory storage medium as recited in claim 11, wherein the calculating of the available resources is performed on an ongoing basis using a greedy comparison between the resources and DTC requirements to avoid idleness and bottlenecks.

20. The non-transitory storage medium as recited in claim 19, wherein use of the greedy comparison minimizes an amount of time between a time when the one component set is executed, and a time when the next component set is executed.
